(19) United States
(12) Patent Application Publication
(10) Pub. No.: US 2018/0143123 A1
(43) Pub. Date: May 24, 2018

(54) SYSTEM AND METHOD FOR SIZING AND IMAGING ANALYTES IN MICROFLUIDICS BY MULTIMODE ELECTROMAGNETIC RESONATORS

(71) Applicant: Mehmet Selim Hanay, Ankara (TR)

(72) Inventor: Mehmet Selim Hanay, Ankara (TR)

(21) Appl. No.: 15/711,067

(22) Filed: Sep. 21, 2017

Related U.S. Application Data
(60) Provisional application No. 62/397,983, filed on Sep. 22, 2016.

(51) Int. Cl. G01N 15/10; G01B 15/00; G01N 22/00

(52) U.S. Cl. CPC G01N 15/1031; G01F 1/66; G01N 22/00; G01B 15/00

(57) ABSTRACT

A method and apparatus for sizing and imaging an analyte. The apparatus including an electromagnetic resonator, an input port, an output port, a microfluidic substrate, and a microfluidic channel having a first fluid port and a second fluid port wherein a first analyte species is manipulated and analyzed within the microfluidic channel. The electromagnetic resonator further including at least one ground plane for the electromagnetic resonator, and at least one signal path for the electromagnetic resonator.

### CROSS-REFERENCE TO RELATED APPLICATIONS

This application is a Non-Provisional Patent Application filed under 35 U.S.C. § 119(e) of U.S. Provisional Patent Application No. 62/397,983 filed on Sep. 22, 2016, which application is hereby incorporated by reference in its entirety.

### FIELD

The disclosure relates to systems for sizing and imaging analytes, more particularly to systems for sizing and imaging analytes in microfluidics, and, even more specifically, to sizing and imaging analytes in microfluidics using multimode microwave resonator sensors.

### BACKGROUND

Microfluidics or lab-on-a-chip systems have the potential to offer point-of-care diagnostics. However, their use is seriously hampered by the fact that an optical system, usually a bulky microscope, is required to obtain an image of the sample. A compact electronic sensor for microfluidics have been the microwave resonators whereby the passage of an analyte of interests changes the resonance frequency of the sensor.

United States Patent Application Publication No. 2013/068622 discloses capacitances used in a microfluidic channel to obtain the effective electrical volume of droplets (e.g. if the droplet geometric volume is fixed, then the capacitance change can be related to the mixing ratios of different components in a droplet). However, this technique does not measure the shape of an arbitrary droplet since it does not use the geometric variation of higher order modes. United States Patent Application Publication No. 2014/0248621 discloses the detection of species through a channel by using an array of capacitive sensors which must be read simultaneously or through multiplexing.

Thus, there is a long-felt need for a system for obtaining size, shape and position information of an analyte and use this information to construct an image of the analyte.

### SUMMARY

According to aspects illustrated herein, there is provided a method for sizing and imaging an analyte including the steps of obtaining a location and a velocity of a species of analyte traveling inside a volume of an electromagnetic resonator, using the location and the velocity to at least one cell transit and mechanotyping experiment, obtaining a spatial property of the species of analyte, and using the spatial property of the species of analyte to obtain an image of the species of analyte.

According to aspects illustrated herein, there is provided an apparatus for sizing and imaging an analyte including an electromagnetic resonator, an input port, an output port, a microfluidic substrate, and a microfluidic channel having a first fluid port and a second fluid port wherein a first analyte species is manipulated and analyzed within the microfluidic channel. The electromagnetic resonator further including at least one ground plane for the electromagnetic resonator, and at least one signal path for the electromagnetic resonator.

These, and other objects and advantages, will be readily appreciable from the following description of preferred embodiments and from the accompanying drawings and claims.

### BRIEF DESCRIPTION OF THE SEVERAL VIEWS OF THE DRAWINGS

The nature and mode of operation of the present disclosure will now be more fully described in the following detailed description of the embodiments taken with the accompanying figures, in which:

FIG. 1 is a perspective view of a multimode microwave resonator sensor integrated with a microfluidics channel;

FIG. 2 is a perspective view of a three-dimensional microwave imaging system;

FIG. 3a is a perspective of a two-dimensional microwave imaging system;

FIG. 3b is a perspective of a (1,1) mode of the electromagnetic field inside the resonator;

FIG. 3c is a perspective of a (2,1) mode of the electromagnetic field inside the resonator;

FIG. 3d is a perspective of a (1,2) mode of the electromagnetic field inside the resonator;

FIG. 3e is a perspective of a (1,3) mode of the electromagnetic field inside the resonator;

FIG. 3f is a perspective of a (1,4) mode of the electromagnetic field inside the resonator;

FIG. 3g is a perspective of a (2,2) mode of the electromagnetic field inside the resonator;

FIG. 4 is a graphical representation of the analysis of particle location using finite element simulations;

FIG. 5 is a measurement of a particle location and electrical volume from two mode measurements;

FIG. 6 is a graphical representation of the analysis results for the size, location, and dielectric constant of particles that have been reverse calculated using the system provided herein.

### DETAILED DESCRIPTION OF EMBODIMENTS

At the outset, it should be appreciated that like drawing numbers on different drawing views identify identical, or functionally similar, structural elements. While the embodiments are described with respect to what is presently considered to be the preferred aspects, it is to be understood that the invention as claimed is not limited to the disclosed aspect. The present invention is intended to include various modifications and equivalent arrangements within the spirit and scope of the appended claims.

Furthermore, it is understood that this disclosure is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

The sizing and imaging system for analytes in microfluidics 1 comprises; At least one signal path for the electromagnetic resonator 2 and at least one electrode as the ground plane 3 of the resonator. The resonator is probed through input/output ports such as 4 and 5 connectors, but can also be any other suitable connector. There are at least two fluidic ports 6 and 7 on the platform to transport liquids into and out of the microfluidic channel 8 where the analyte species 9 are manipulated and analysis takes place. A suitable substrate made out of such as but not limited to PDMS, glass, silicon, functions as the microfluidic chip substrate 10 carrying all the subunits of the system. During the operation of the invention, multiple electromagnetic modes—such as but not limited to the first mode 11, the second mode 12, the third mode 13 etc.—are excited and their resonance frequencies are tracked. The location, size and shape of the analyte 9 changes the frequencies of such modes. By measuring these frequency shifts in multiple modes and applying the analysis procedure presented, it is possible to obtain the different moments (and expected values of any other suitable, well-behaved function) of the distribution function of the particle and generate a 1D image of the particle.

To obtain a 3D image of the particle, three-dimensional multimode electromagnetic resonator imaging system can be used 14 which comprises; When described in a Cartesian coordinate system denoted in 15, a resonator with a microstrip line along the y-direction 16, another resonator with a microstrip line along the z-direction 17, another resonator with a microstrip line along the x-direction 18 and their corresponding grounding planes at the opposite end of the prismatic platform. Each of these resonators may have slightly different lengths to offset their frequencies and reduce crosstalk, or they may have the same lengths and frequencies and discriminated from each other through the input/output electrical ports. The device contains at least two microfluidic input/output ports 19 and 20, respectively, to connect to external reservoirs, a microfluidic channel 21 and a species to be analyzed 22 transporting across the intersection of the region where all three resonators have their maximal electrical field. Each of the perpendicular resonators will generate a 1D profile of the analyte, and combination of each of these profiles generate a 3D image of the analyte.

To obtain a direct 2D image of the particle, direct two-dimensional multimode electromagnetic resonator imaging system can be used 23 which comprises; a two-dimensional resonator signal plate which can be rectangular in shape as in 24 or it can have any other two-dimensional or quasi-two-dimensional shape such as but not limited to a circular or elliptical disc; its corresponding ground plane 25; external electrical coupling ports such as the capacitive coupling ports shown in 26, 27, 28, 29 or other forms of electrical coupling forms such as inductive coupling loops or wirebonds; may contain fluidic inlet/outlet ports from/to the external reservoirs such as 30,31; may contain a microfluidic channel 32 where the analyte 33 travels. The two-dimensional mode shapes such as the (1,1) mode shape 34, (2,1) mode shape 35, (1,2) mode shape 36, the (1,3) mode shape 37, the (1,4) mode shape 38 and the (2,2) mode shape 39 are shown. The interaction of the two-dimensional permittivity density distribution of an analyte (x, y) will generate frequencies in each mode. By forming appropriate superpositions of such frequency shifts, it is possible to obtain the spatial properties, such as geometrical moments, Legendre moments and Zernike moments of this distribution. Once such moments are obtained, then they can be used to reverse calculate the 2D image of the analyte.

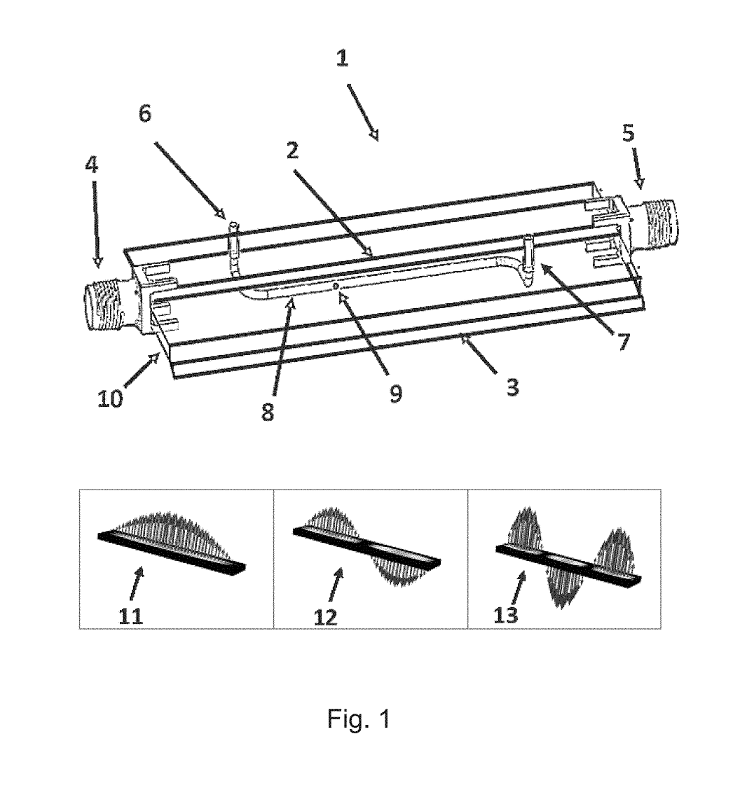

Analytes inside a microfluidic channel can be characterized by applying an electrical potential across the channel and probing the response of the system. One approach commonly used is to directly probe the capacitance of the channel by applying low-frequency electrical signals. In this case, the dielectric constant between the capacitive electrodes are changed by a passing particle. Working at low frequencies suffers from Debye screening which shields the penetration of applied electrical fields into the solution. At higher frequencies, ions cannot react fast enough and the screening effects become negligible. For this reason, working at high frequencies, such as the microwave regime, is highly desirable. By creating a microwave resonator and tracking its resonance frequency accurately, it is possible to probe the changes inside the microwave channel. Cell counting and channel heating has been accomplished so far with the technique described in Lab on a Chip, (Label-free high-throughput detection and content sensing of individual droplets in microfluidic systems) by Yesiloz, G., Boybay, M. S. & Ren, C. L, which reference is hereby incorporated by reference in its entirety. However, there is still an untapped resource to obtain further sensory data: the use of higher order modes from the same resonator. The use of higher order modes have significantly advanced the mechanical sensor research, and in this paper we explore how similar approaches can be applied for microwave microfluidics (FIG. 1). Use of higher order modes can be found in: Dohn, S., Svendsen, W., Boisen, A. & Hansen, O. Mass and position determination of attached particles on cantilever based mass sensors. Rev Sci Instrum 78, 103303, doi:doi:10.1063/1.2804074 (2007); Dohn, S., Schmid, S., Amiot, F. & Boisen, A. Position and mass determination of multiple particles using cantilever based mass sensors. Applied Physics Letters 97, 044103, doi:Artn 044103, doi: 10.1063/1.3473761 (2010); Gil-Santos, E. et al. Nanomechanical mass sensing and stiffness spectrometry based on two-dimensional vibrations of resonant nanowires. Nature Nanotechnology 5, 641-645, doi:10.1038/nnano.2010.151 (2010); Hanay, M. S. et al. Single-protein nanomechanical mass spectrometry in real time. Nature Nanotechnology 7, 602-608, doi:10.1038/nnano.2012.119 (2012); Hanay, M. S. et al. Inertial imaging with nanomechanical systems. Nature nanotechnology 10, 339-344 (2015); and, Olcum, S., Cermak, N., Wasserman, S. C. & Manalis, S. R. High-speed multiple-mode mass sensing resolves dynamic nanoscale mass distributions. Nature communications 6 (2015), which references are hereby incorporated by reference in their entireties.

Detailed information about the spatial properties of analyte particles—such as their real-time position, extent, symmetry etc.—can be obtained by using higher order electromagnetic modes. Moreover, once these spatial parameters are obtained, they can be used to reconstruct the image of an analyte passing through a microfluidic channel. The interaction of the sample by each resonator mode will generate a frequency shift that depends on the spatial overlap between the particle and the electromagnetic mode. The frequency shift data from multiple modes are then processed with an algorithm to obtain the electrical volume of the particle, the center position, the skewness of the particle and so on. Unlike capacitance based sensing where multiple capacitive electrodes need to be fabricated and measured, proposed technique uses only a single electrode and achieves a resolution which is not limited by the wavelength of the resonance mode. All the electrical measurements can be accomplished using one electrical connection to the single electrode by multiplexing electronic frequencies. By using customized microwave components, it is possible to form a low-cost and mobile imaging platform for microfluidic chips to be used as lab-on-chips with no bulky and expensive optical components.

In dielectric impedance sensing, discussed in Ingebrandt, S. Bioelectronics: Sensing beyond the limit. Nature nanotechnology 10, 734-735 (2015); (See also: Pozar, D. M. Microwave engineering. (John Wiley & Sons, 2009); and, Boybay, M. S., Jiao, A., Glawdel, T. & Ren, C. L. Microwave sensing and heating of individual droplets in microfluidic devices. Lab on a Chip 13, 3840-3846 (2013)), a small particle passing through a channel changes the effective permittivity of the resonator and induce a shift in the resonance frequency of the mode:

$$\frac{Δ f}{{f}_{n}} = - \frac{{\int }_{{V}_{0}}^{ } Δ ∈ ( r ) {E}_{n}^{2} ( r ) {d}^{3} r}{{\int }_{{V}_{0}}^{ } ( ∈ ( r ) {E}_{n}^{2} + μ ( r ) {H}_{n}^{2} ) {d}^{3} r}$$

where fₙ is the original resonance frequency of the mode, Δfᵢᵢ is the change in resonance frequency (i.e. the signal used for sensing), Δ∈ is the difference between the dielectric constant of the analyte particle and the liquid that it displaces, ∈ is the dielectric constant of the medium, μ is the permittivity of the medium, Eₙ is the electrical field and Hₙ is the magnetic field for the n^{th} mode.

By noting that the denominator is the total energy stored in the resonator Eᵣₑₛ, working with fractional frequency shifts

$$( δ {f}_{n} ≡ \frac{Δ f}{{f}_{n}} ) ,$$

and using the harmonic oscillator property (<∫∈Eₙ²d³r>=<∫μHₙ²d³r>, one may rewrite the above equation as:

$$δ {f}_{n} = - \frac{{\int }_{{V}_{0}}^{ } Δ ∈ ( r ) {∅}_{n}^{2} ( r ) {d}^{3} r}{2 {V}_{n}}$$

Where Vₙ is the effective electrical volume of the mode: Vₙ=∫Δ∈(r)Øₙ²(r)d³r and the overall strength of the electrical field Eₙ drops out.

Using this equation as starting point, spatial properties of the particle's distribution function Δ∈(r) can be probed. Here, we will consider a microstrip line with a buried microfluidics channel underneath as the model platform to implement the ideas: other types of resonators can also be approached within the same framework. We will first describe the point-like particle approximation for the analyte and show how the position of the particle can be detected by two mode measurements. Moreover, to detect the electrical volume and position of N particles, N modes can be used. The point-particle approximation and the two-mode solution will facilitate the subsequent analysis. After this illustrative solution, we will attack the more general case of a finite size particle and demonstrate how the measurement of first N modes will yield the first N moments of the particle's distribution and how these moments may be used to reconstruct the image of a particle.

The following is a description of Point-Particle Approximation and the Determination of Particle's Position. For a point particle, one can write Δ∈(r)=υ(r−rₚ) where rₚ is the position of the particle, δ is the Dirac-Delta function and v is the total excess electric volume of the particle. Without loss of generalization, one can consider a one-dimensional microstrip line (FIG. 1) as a generic electromagnetic resonator to probe the particle's position along the axial direction. (To obtain the position in 3D, three perpendicular resonators may be used.) The frequency shifts in the first two modes then read:

$$δ {f}_{1} = - \frac{v}{2 {C}_{1}} {{∅}_{1} ( x )}^{2}$$

$$δ {f}_{2} = - \frac{v}{2 {C}_{2}} {{∅}_{2} ( x )}^{2}$$

For a given platform, the effective capacitances (Cₙ) can be calculated leaving two unknowns of the problem (v, x) and two equations. If the electromagnetic resonator is designed so that

$${( \frac{{∅}_{1} ( x )}{{∅}_{2} ( x )} )}^{2}$$

is an invertible function then these equations can be solved and the position for the particle can be determined.

As an illustration of two-mode sensing principle in the point-particle approximation, we study the passage of a droplet along a microfluidic channel. We consider the situation whereby the microfluidics channel flows in parallel to and directly below the signal path of the microstrip line. A particle placed at different locations will generate different frequency shifts which scale as the square of the electric field (E²(r)). The electric field has only z-component directly underneath the microstrip line: E(r)=E(r)\hat{k}. Moreover, the electric field will have only slight variation in the y- and z-directions since the microfluidic channel has a very small cross-section. In this case, we can express the n^{th} mode of the electric field as:

E(r)=AₙØₙ(x)\hat{k}

where Aₙ is the modal amplitude and φ) x is the mode shape function for the resonator. For a microstrip line terminated with shorts, this function can be expressed as:

Ø(x)=sin(πnx)

where the spatial coordinate x is taken to be normalized with respect to the length of the microstrip line (L).

The frequency shift caused by a particle with an excess dielectric mass v can be calculated as:

$$δ {f}_{n} = - \frac{v}{2 C} {sin}^{2} ( n π x )$$

By using the first two modes and restricting the analysis to the first half of the sensor (0<x<0.5) one can obtain:

$$x = \frac{1}{π} arccos ( \sqrt{\frac{δ {f}_{2}}{4 δ {f}_{1}}} )$$

Once the location is known, then the (excess) electrical volume of the analyte can also be determined by any of the modal equations.

In FIG. 1, we show FEM Simulations for a particle at different locations and show that the formula above can correctly calculate the position of the particle. This is a significant advance: the location of a particle in a microfluidics channel can be read without a microscope or a multiplexed sensor arrays. By using only one electrical conductor and two modes, the location of the particle can be inferred in real time. In this way, trajectory and speed of the particle may also be determined in real-time throughout the channel. With one mode sensing, the trajectory of the particle can be determined only after the particle passes through the middle point where the maximal value of the frequency shift is used as an indicator. With capacitive sensing, the particle's location can be determined when the particle is in close proximity with the capacitive electrode. With the two mode technique, however, the particle's location is known at any moment. Therefore, accurate position and velocity measurements, e.g. for transit time experiments or real-time feedback control of particle location can be accomplished without any need for a microscope based imaging system (see Nyberg, K. D. et al. The physical origins of transit time measurements for rapid, single cell mechanotyping. Lab on a Chip (2016)).

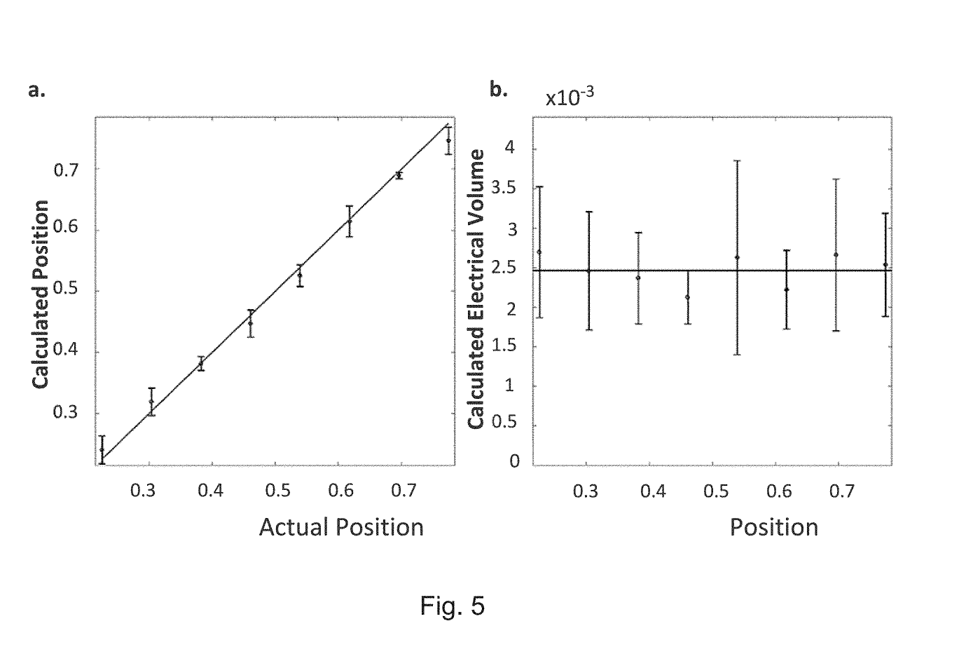

The following relates to experimental realization of position and electrical volume sensing of the system disclosed herein. To implement the two mode detection principle, we fabricated a microstripline resonator on a PCB. Small holes are drilled along the axis of the signal path of the microstripline to place analyte droplets. Glycerin was used as analyte due to its low vapor pressure and ease of handling. A volume of 1.8 μL of glycerin was pipetted into these holes. The resonance shifts before and after were measured using a spectrum analyzer with tracking generator capability. The results are shown in FIG. 5. FIG. 5a shows the position detection calculated from the frequency shifts of both modes. In this figure, the measurement results of five data sets are averaged. The data points near the center of the resonator shows good agreement with the expected locations of the droplets. As the droplets are placed near the edges, the responsivity functions for each mode drop down: as a results, the signal-to-noise ratio of the measurements decrease and the measurements are less accurate. Moreover, these points are also more prone to non-idealities in boundary conditions. Nevertheless, the general trend is well established.

The electrical volume of the particle can also be determined as shown in FIG. 5b. The value for the electrical volume agrees with each other within the accuracy of the micropipette used.

When the dimensions of the particle are taken to have a finite size, then it is more appropriate to use the integral equation presented before. Using this equation with many different modes, one may obtain the relevant electrical and spatial information. The main idea employed here is that the information from different modes can be utilized if a suitable superposition is formed:

$${\sum }_{n = 1}^{n = N} {α}_{n} δ {f}_{n} = - \frac{1}{V} {\int }_{{V}_{0}}^{ } Δ ∈ ( r ) [ {\sum }_{n = 1}^{n = N} {α}_{n} {E}_{n}^{2} ( r ) ] {d}^{3} r$$

By picking suitable values for α), as shown before, one may obtain a target function (r) which can yield spatial information about the particle:

$${\sum }_{n = 1}^{n = N} {α}_{n} δ {f}_{n} = - \frac{1}{V} Δ ∈ ( r ) g ( r ) {d}^{3} r$$

For instance, if the target function g r is equal to the unity function, then the total dielectric volume of the particle will be obtained. A different selection of αₙ coefficients will generate a different target function; for instance g r=x will give the mean position of the particle <x>. To obtain a proxy for the size of the particle, standard deviation and variance of the electrical volume can be used by constructing, for example, the superposition:

g(r)=(x−<x>)²

To obtain the target function g(r), the optimal choice for the αₙ coefficients is:

αₙ=Tₘₙ⁻¹bₘ

where Tₘₙ is the overlap integral between the responsivities of modes:

Tₘₙ=∫_{Ω}Eₙ²(r)Eₘ²(r)d³r

And bₘ is the overlap integral between the responsivity and the target function:

bₘ=∫_{Ω}g(r)Eₘ²(r)d³r

By evaluating these overlap integrals, one can choose suitable αₙ coefficients to construct a superposition integral which calculates a specific moment of the particle's shape.

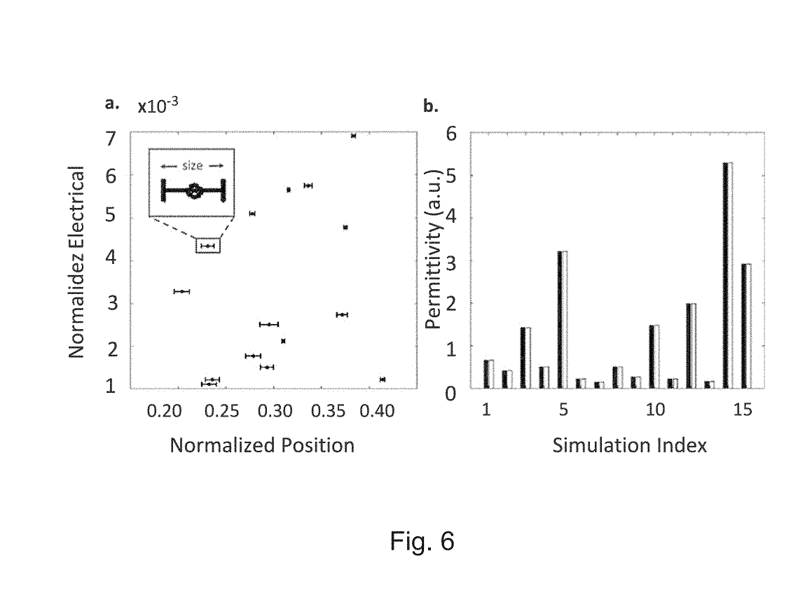

To demonstrate the calculation of geometrical size (as opposed to electrical volume), we performed Monte Carlo simulations in Matlab where the location, size and the permittivity of the particles are changed. The frequency shifts in the microwave resonator were generated using equation 1 and then processed by choosing appropriate values of weights using equation 2. Electrical volume, location and the variance of the particle were calculated in order. The variance values were then converted to size by assuming a uniform, prismatic shape of a particle. An ensemble of 100 Monte Carlo particles were generated and analyzed in this way. The first 15 particles of the ensemble are illustrated in FIG. 6: the location and mass are marked on x- and y-axis respectively: the size of the particle is shown as the size of the horizontal bar.

Once the geometrical size is determined, it can be combined with the electrical volume measurements to obtain the mean permittivity of the particle. For the Monte Carlo simulations, the actual and calculated permittivity values for the particles are shown in FIG. 6.

Once enough number of moments are acquired, this information is used to reconstruct the shape, i.e. image of the analyte. Initial idea has been to use the regular moments of the distribution and reverse calculate the distribution (i.e. shape) of the analyte. However, other choices for the target function g(r) can be generated as shown before, among them Legendre moments (for 1D and 2D) and Zernike moments (for 2D) are more optimal for image reconstruction since these functions (g(r)) form orthogonal bases so that information redundancy is not seen (see Teague, M. R. Image analysis via the general theory of moments. JOSA 70, 920-930 (1980); and, John, V., Angelov, I., Öncüll, A. & Thévenin, D. Techniques for the reconstruction of a distribution from a finite number of its moments. Chemical Engineering Science 62, 2890-2904 (2007)).

Another way to construct the image would be to use direct Maximum Entropy construction which treats each frequency shift equation as a separate, special moment of the distribution and reconstructs the image:

$$p ( x ) = exp - ( - {\sum }_{n = 1}^{N} {λ}_{n} {φ}_{n}^{2} ( x ) )$$

where each of the coefficient in the constructions are found from Lagrange multiplier expression:

$${G}_{n} ( λ ) = \int {φ}_{n}^{2} ( x ) exp ( {\sum }_{n = 1}^{N} {λ}_{n} {φ}_{n}^{2} ( x ) ) = δ {f}_{n}$$

The following should read with respect to imaging in 2D and 3D. To obtain images at higher order, two different approaches will be used: in the first one, a two-dimensional resonator will be used to probe the two dimensional projection of particle's distribution function ∈(x, y). In the second approach, three one dimensional microstripline resonators will be arranged perpendicular to each other so that the profile in 3D can be obtained and merged to create a single image.

To take the advantage of Zernike polynomials, circular microwave resonators will be constructed on PDMS. With the 2D mode shapes (Bessel functions) one then can obtain the Zernike polynomials which are used commonly for 2D image reconstruction.

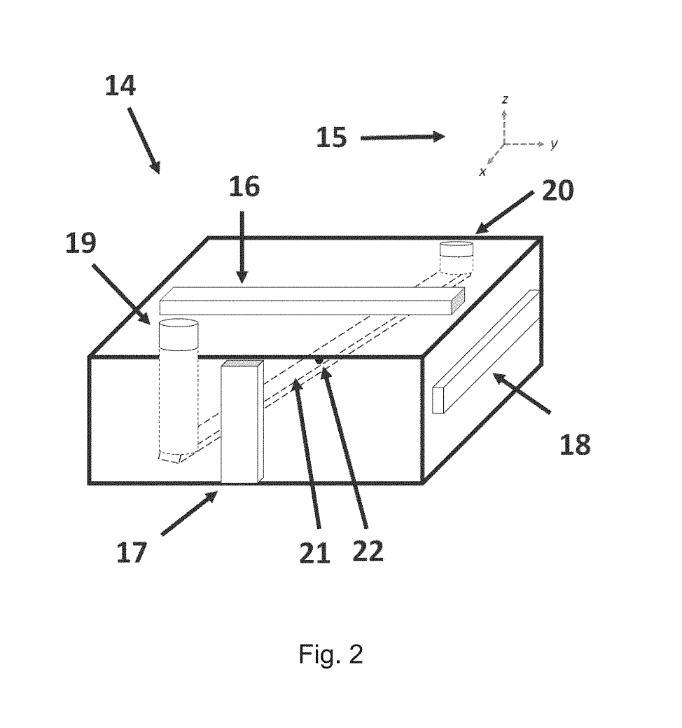

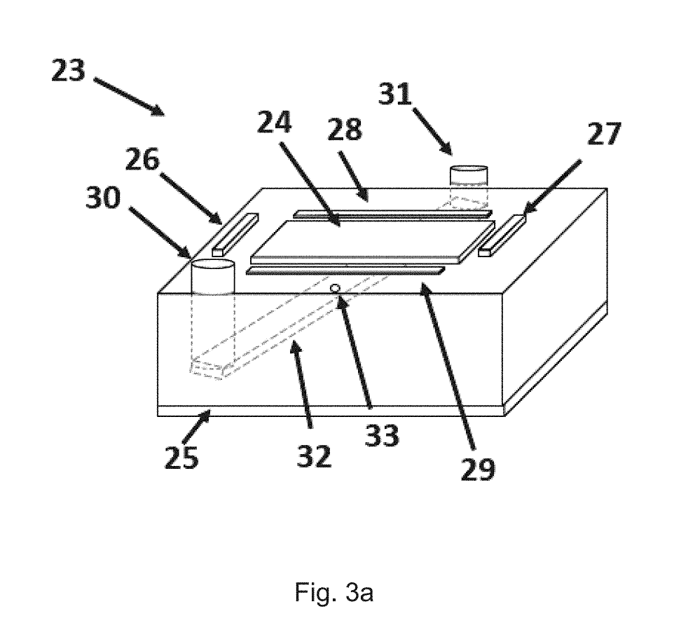

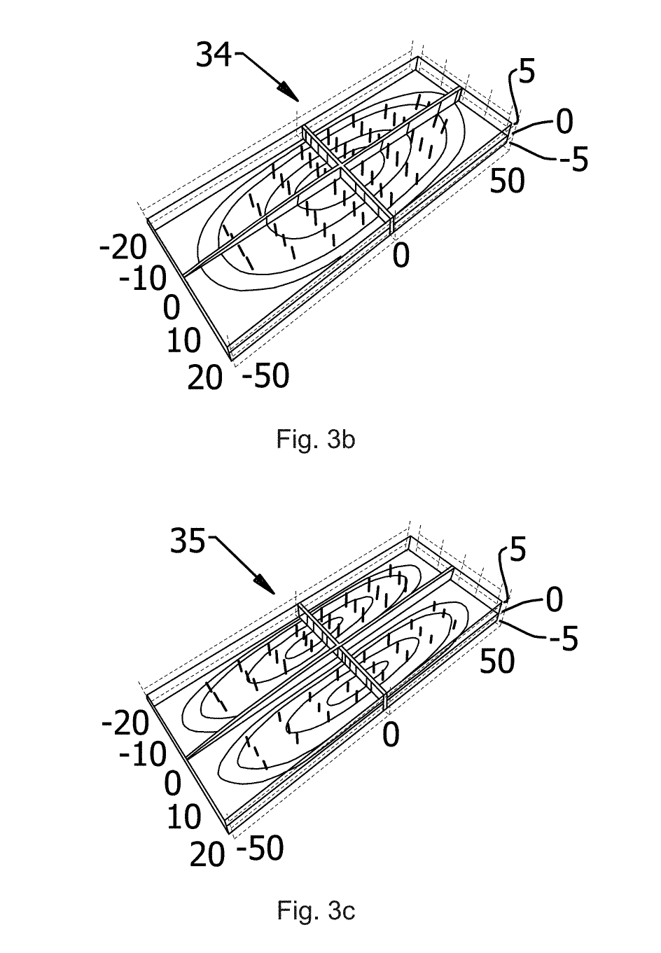

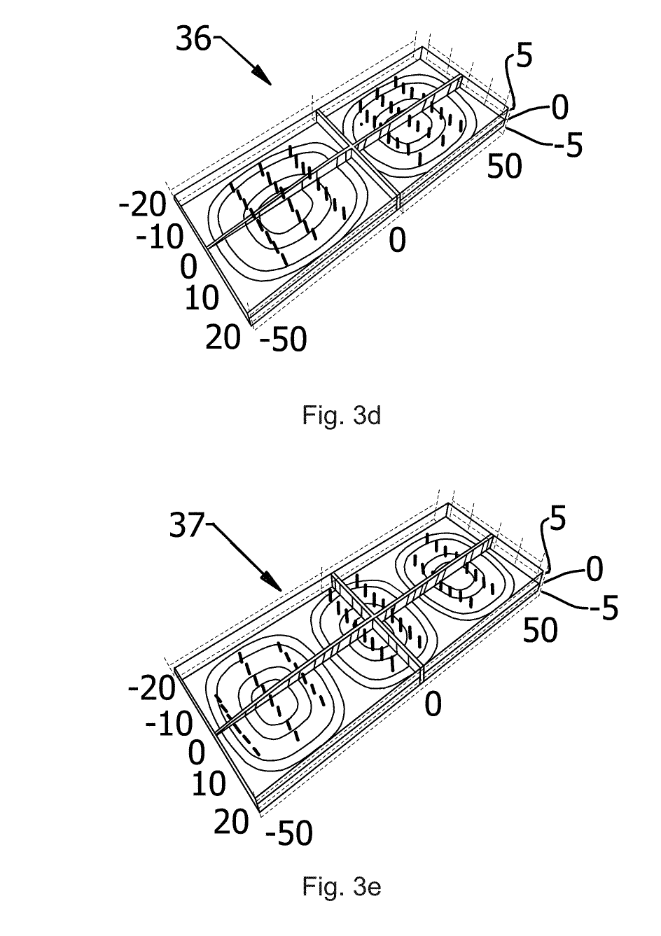

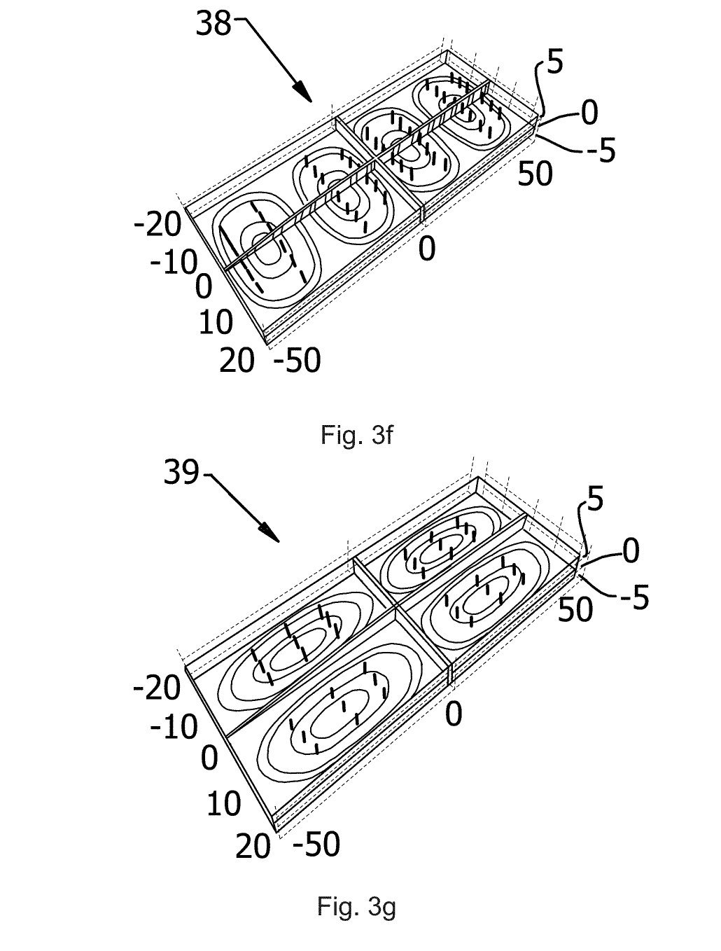

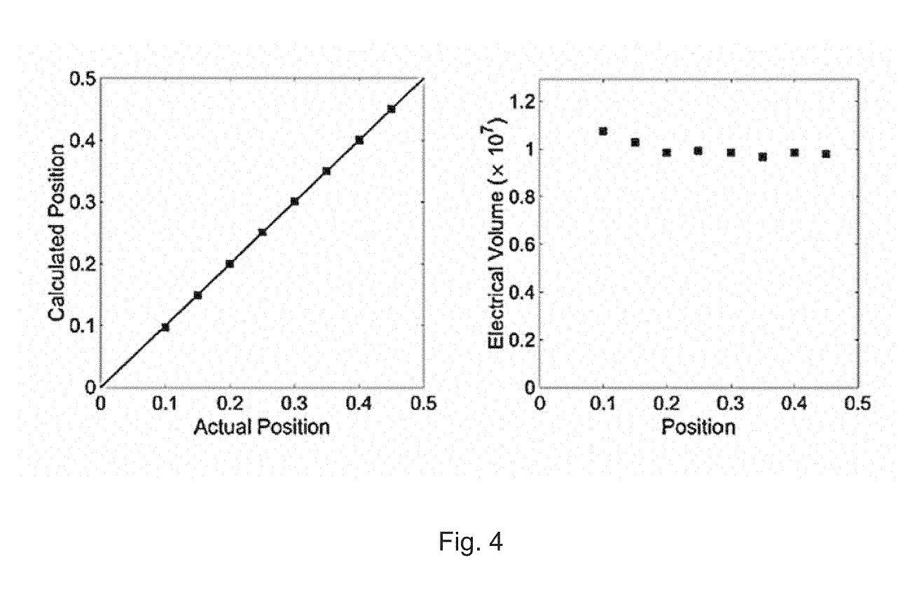

The proposed technique has the following advantages: it can track the location of a species throughout the resonator unlike proximity electrode based devices. Moreover, by using higher order modes, the spatial characteristics of the species can be measured. From these measurements, an image of the species can be constructed using electromagnetic resonators. With these techniques, it is possible to perform transit time measurements to gauge the mechanical properties of live cell, e.g. for detection of Circulating Tumor Cells (CTCs) without the need for optical instruments or mechanical resonators. Moreover, three such electromagnetic resonators may be placed in perpendicular to each other so that the location, size and shape in 3D can be obtained as depicted in FIG. 2, or two-dimensional resonators may be used.

The analogy between mechanical and electromagnetic resonators has been a celebrated paradigm that scientists and engineers learn early in their studies. Exploration of this analogy in recent years have produced several exciting research directions: cavity optomechanics as discussed in Kippenberg, T. J. & Vahala, K. J. Cavity opto-mechanics. Optics Express 15, 17172-17205 (2007); phononic bandgap materials as discussed in Maldovan, M. Sound and heat revolutions in phononics. Nature 503, 209-217 (2013); and phononic metamaterials as discussed in: Chen, H. & Chan, C. Acoustic cloaking in three dimensions using acoustic metamaterials. Applied physics letters 91, 183518 (2007); Xie, Y., Popa, B.-I., Zigoneanu, L. & Cummer, S. A. Measurement of a broadband negative index with space-coiling acoustic metamaterials. Physical review letters 110, 175501 (2013); and, Cummer, S. A. & Schurig, D. One path to acoustic cloaking. New Journal of Physics 9, 45 (2007), which references are hereby incorporated by reference in their entireties. In these examples, progress in electromagnetic research has usually lead the way for their mechanical counterparts. Here, we contribute to this analogy from the other way around by adapting a sensing technique originally developed for mechanical sensors to increase the capabilities of sensors based on electromagnetic fields. More specifically, multimode resonance techniques in inertial mass sensing experiments with Micro- and Nanoelectromechanical Systems (MEMS/NEMS) are tailored to be used for the high frequency impedance spectroscopy. High frequency Impedance spectroscopy as discussed in Elbuken, C., Glawdel, T., Chan, D. & Ren, C. L. Detection of microdroplet size and speed using capacitive sensors. Sensors and Actuators A: Physical 171, 55-62 (2011), which probes the interaction of microwave fields with analyte particles, has gained importance in recent years in the field of microfluidics as the technique potentially enables cell counting. With the progress presented here, it is possible to go beyond simple counting and achieve sizing and imaging of analytes with impedance spectroscopy.

Thus it is seen that the objects of the invention are efficiently obtained, although changes and modifications to the invention should be readily apparent to those having ordinary skill in the art, which changes would not depart from the spirit and scope of the invention as claimed.

### LIST OF REFERENCE NUMBERS

1 Sizing and imaging system
2 The signal path for the microwave resonator
3 The ground plane for the microwave resonator
4 Input/Output electrical connection in the form of an SMA connector
5 Input/Output electrical connection in the form of an SMA connector
6 Input/Output fluidic port to external reservoirs
7 Input/Output fluidic port to external reservoirs
8 Microfluidic channel
9 Species to be analyzed inside the microfluidics channel
10 Microfluidic chip substrate
11 The first mode of the electromagnetic field along the microfluidic channel
12 The second mode of the electromagnetic field along the microfluidic channel
13 The third mode of the electromagnetic field along the microfluidic channel
14 Three-dimensional multimode electromagnetic resonator imaging system
15 Coordinate system used to label the directions in the figure
16 Resonator signal path along the y-direction
17 Resonator signal path along the z-direction
18 Resonator signal path along the x-direction
19 Input/Output fluidic port to external reservoirs
20 Input/Output fluidic port to external reservoirs
21 Microfluidic channel
22 Species to be analyzed inside the microfluidics channel
23 Two-dimensional multimode electromagnetic resonator imaging system
24 Signal electrode of the two-dimensional resonator
25 Ground plane of the two-dimensional resonator
26 Input/Output coupling electrode for the resonator
27 Input/Output coupling electrode for the resonator
28 Input/Output coupling electrode for the resonator
29 Input/Output coupling electrode for the resonator
30 Input/Output fluidic port to external reservoirs
31 Input/Output fluidic port to external reservoirs
32 Microfluidic channel
33 Species to be analyzed inside the microfluidics channel
34 The (1,1) mode of the electromagnetic field inside the resonator
35 The (2,1) mode of the electromagnetic field inside the resonator
36 The (1,2) mode of the electromagnetic field inside the resonator
37 The (1,3) mode of the electromagnetic field inside the resonator
38 The (1,4) mode of the electromagnetic field inside the resonator
39 The (2,2) mode of the electromagnetic field inside the resonator

What is claimed is:

1. A method for sizing and imaging an analyte comprising:
obtaining a location and a velocity of a species of analyte traveling inside a volume of an electromagnetic resonator;
using the location and the velocity to at least one cell transit and mechanotyping experiment;
obtaining a spatial property of the species of analyte; and,
using the spatial property of the species of analyte to obtain an image of the species of analyte.

2. The method for sizing and imaging an analyte of claim 1 further comprising the steps of:
using a plurality of perpendicular electromagnetic resonators to obtain a first one-dimensional image along a first direction and a second one-directional image along a second direction; and,
merging the first one-dimensional image and the second one-dimensional image to obtain a first higher dimensional image.

3. The method for sizing and imaging an analyte of claim 1 wherein the special properties are selected from: the position, a standard deviation of a size, a skewness, a peakedness, a higher order geometric moment, or a Legendre polynomial.

4. The method for sizing and imaging an analyte of claim 1 wherein a 2D image of the image of the species of analyte is directly obtained using two-dimensional resonators.

5. The method for sizing and imaging an analyte of claim 1 wherein a 3D image of the image of the species of analyte is directly obtained using three-dimensional resonators.

6. The method for sizing and imaging an analyte of claim 1 wherein a hollow microtube or a hollow nanotube is used as a waveguide resonator.

7. The method for sizing and imaging an analyte of claim 1 wherein a plurality of modes of the hollow microtube or the hollow nanotube multiple modes are used for an image reconstruction for characterization.

8. The method for sizing and imaging an analyte of claim 1 wherein the first higher order mode is used in optomechanical detection.

9. The method for sizing and imaging an analyte of claim 1 wherein the first higher order mode is used in optical resonators such as a disc shape resonator.

10. The method for sizing and imaging an analyte of claim 1 wherein a superposition of a plurality of modes is used for localized heating.

11. The method for sizing and imaging an analyte of claim 1 further comprising the step of:
sorting of a plurality of particles by the position and a size is performed in real-time.

12. The method for sizing and imaging an analyte of claim 1 further comprising the steps of:
sending a plurality of standard particles through a channel;
collecting a first set of data at a plurality of different modes; and
using the first set of data to tune at least one alpha coefficient using machine learning techniques.

13. The method for sizing and imaging an analyte of claim 1 further comprising the steps of:
referencing of a plurality of frequencies by keeping at least two microstrip lines in parallel, the at least two microstrip lines further comprising a first microstrip line with the analyte and a second microstrip line without the analtye.

14. An apparatus for sizing and imaging an analyte comprising:
an electromagnetic resonator further comprising;
at least one ground plane for the electromagnetic resonator; and,
at least one signal path for the electromagnetic resonator;
an input port;
an output port;
a microfluidic substrate; and,
a microfluidic channel having a first fluid port and a second fluid port;
wherein a first analyte species is manipulated and analyzed within the microfluidic channel.

15. The apparatus for sizing and imaging an analyte of claim 1 wherein the microfluidic substrate is selected from: poly(dimethylsiloxane), glass, or silicon.
